(19) United States
(12) Patent Application Publication
(10) Pub. No.: US 2025/0119962 A1
(43) Pub. Date: Apr. 10, 2025

(54) CONFIGURATION INFORMATION ACQUISITION METHOD, CONFIGURATION INFORMATION FORWARDING METHOD, AND TERMINAL DEVICE

(71) Applicant: GUANGDONG OPPO MOBILE TELECOMMUNICATIONS CORP., LTD., Dongguan (CN)

(72) Inventors: Boyuan ZHANG, Dongguan (CN); Qianxi LU, Dongguan (CN); Bingxue LENG, Dongguan (CN)

(21) Appl. No.: 18/985,571

(22) Filed: Dec. 18, 2024

Related U.S. Application Data
(63) Continuation of application No. PCT/CN2022/121511, filed on Sep. 26, 2022.

(51) Int. Cl. H04W 76/14; H04W 40/22

(52) U.S. Cl. CPC H04W 76/14; H04W 40/22

(57) ABSTRACT

A configuration information acquisition method, a configuration information forwarding method, a first terminal device and second terminal device are provided. The configuration information acquisition method includes: receiving first indication information sent by a first network device, the first indication information indicating whether the first network device supports terminal-to-terminal relay; and on the basis of the first indication information, acquiring relay configuration information for the terminal-to-terminal relay.

### CROSS-REFERENCE TO RELATED APPLICATION

This application is a continuation of International Patent Application No. PCT/CN2022/121511 filed on Sep. 26, 2022, the disclosure of which is hereby incorporated by reference in its entirety.

### BACKGROUND

With respect to the terminal-to-terminal relay, the source remote terminal accesses the target remote terminal through a relay terminal with relay function, the source remote terminal, the relay terminal and the target remote terminal are connected through the sidelink, and the relay terminal transmits the data between the source remote terminal and the target remote terminal.

However, the detailed method of how the relay terminal and the remote terminal implement the terminal-to-terminal relay is not involved in the related art. For example, the method of how the relay terminal and the remote terminal acquire the relay configuration information for the terminal-to-terminal relay is not involved in the related art.

### SUMMARY

The present disclosure provides a method for acquiring configuration information, a method for forwarding configuration information, and a terminal device, such that the communication performance of terminal-to-terminal relay may be improved.

In a first aspect, the embodiments of the present disclosure provide a method for acquiring configuration information. The method includes following operations. The first indication information transmitted by a first network device is received. The first indication information indicates whether the first network device supports a terminal-to-terminal relay. The relay configuration information for the terminal-to-terminal relay is obtained based on the first indication information.

In a second aspect, the embodiments of the present disclosure provide a method for forwarding configuration information. The method includes following operations. The first request transmitted by a first terminal device is received. The first request is used for requesting to obtain relay configuration information for terminal-to-terminal relay. A reselection operation of a relay terminal is performed or the relay configuration information or a refusing response message is transmitted to the first terminal device. The refusing response message indicates that the second terminal device refuses to transmit the relay configuration information to the first terminal device.

In a third aspect, the embodiments of the present disclosure provide a first terminal device. The first terminal device includes a transceiver, a processor and a memory, wherein the memory is configured to store a computer program, the processor is configured to call and run the computer program stored in the memory to enable the transceiver to: receive first indication information transmitted by a first network device, wherein the first indication information indicates whether the first network device supports a terminal-to-terminal relay; and obtain relay configuration information for the terminal-to-terminal relay based on the first indication information.

In a fourth aspect, the embodiments of the present disclosure provide a second terminal device, including a transceiver, a processor and a memory, wherein the memory is configured to store a computer program, the processor is configured to call and run the computer program stored in the memory to enable the transceiver and/or processor to perform the method of the second aspect.

### BRIEF DESCRIPTION OF THE DRAWINGS

FIG. 1 is a schematic diagram of mode A according to the present disclosure.

FIG. 2 is a schematic diagram of mode B according to the present disclosure.

FIG. 3 is a schematic diagram of the unicast transmission according to the present disclosure.

FIG. 4 is a schematic diagram of the multicast transmission according to the present disclosure.

FIG. 5 is a schematic diagram of the broadcast transmission according to the present disclosure.

FIG. 6 is a schematic diagram of the sidelink feedback according to the present disclosure.

FIG. 7 is an example of a system framework of terminal-to-network relay according to the present disclosure.

FIG. 8 is a schematic flowchart of the method for acquiring configuration information according to the present disclosure.

FIG. 9 is another schematic flowchart of the method for forwarding configuration information according to the present disclosure.

FIG. 10 is a schematic block diagram of a first terminal device according to the present disclosure.

FIG. 11 is a schematic block diagram of a second terminal device according to the present disclosure.

FIG. 12 is a schematic block diagram of a communication device according to the present disclosure.

FIG. 13 is a schematic block diagram of a chip according to the present disclosure.

### DETAILED DESCRIPTION

The technical solutions in the embodiments of the present disclosure will be described below with reference to the accompanying drawings.

It is to be noted that the terminologies used in the implementations of the present disclosure are for the purpose of explanation of specific embodiments of the present disclosure only, and are not intended to limit the present disclosure. For example, “predefined” or “preset” in the embodiments of the present disclosure may be implemented by storing in advance the corresponding codes, tables, or other manners indicating relevant information in the device (including, for example, the terminal device and the network device), and the specific implementations thereof are not limited in the present disclosure. For example, “preset” may refer to being defined in the protocol. Alternatively, the “protocol” may refer to a standard protocol in the field of communication. For example, it may include an LTE protocol, an NR protocol, and related protocols applied in future communication systems, which are not specifically limited in the present disclosure.

Further, the terminology “indication” may be a direct indication, or an indirect indication, and may also represent that there is an association relationship. For example, A indicates B, which may mean that A directly indicates B, for example, B may be acquired through A. It may also mean that A indicates B indirectly, for example, A indicates C, and B may be acquired through C. It may also indicate that there is an association relationship between A and B. The terminology “corresponding” may indicate that there is a direct correspondence or indirect correspondence between the two items, may also indicate that there is a correlation relationship between the two items, or may indicate a relationship between indicating and being indicated, configuring and being configured, or the like. In addition, the description of “when” in the embodiments of the present disclosure may be interpreted as “if” or “in case” or “when” or “in response to”. Similarly, depending on the context, the phrase “if it is determined” or “if it is detected (a stated condition or event)” may be interpreted as “when it is determined” or “in response to determination of” or “when it is detected (a stated condition or event)” or “in response to detection of (a stated condition or event)”. Further, in the embodiments of the present disclosure, the term “and/or” is merely a kind of association relationship describing the associated objects, and indicates that there may be three kinds of relationships. Specifically, A and/or B may represent three cases: A exists alone, both A and B exist, and B exist alone. Further, the character “/” in the present disclosure generally means that the associated objects has an “or” relationship. The terms “first”, “second”, etc. in the specification, claims and the accompanying drawings of the disclosure are used to distinguish different objects and are not used to describe a particular order. Further, the terms “comprising” and “including”, as well as any variations thereof, are intended to cover the non-exclusive inclusion.

The technical solutions of the embodiments of the present disclosure may be applied to various communication systems.

Exemplarily, the communication system to which the technical solution of the embodiments of the present disclosure may be applied include, but not limited to, a Global System of Mobile communication (GSM) system, a Code Division Multiple Access (CDMA) system, and a Wideband Code Division Multiple Access (WCDMA) system, General Packet Radio Service (GPRS), Long Term Evolution (LTE) system, Advanced long term evolution (LTE-A) system, New Radio (NR) system, evolution of NR system, LTE-based access to unlicensed spectrum (LTE-U) system, NR-based access to unlicensed spectrum (NR-U) system, Non-Terrestrial Networks (NTN) system, Universal Mobile Telecommunication System (UMTS), Wireless Local Area Networks (WLAN), Wireless Fidelity (WiFi), a fifth-generation (5G) communication system, or other communication systems, etc.

The embodiments of the present disclosure may be applied to any communication architecture of terminal device-to-terminal device.

Exemplarily, the embodiments of the present disclosure may be applied to the communication framework such as a Device to Device (D2D) communication, a Machine to Machine (M2M) communication, a Machine Type Communication (MTC), a Vehicle to Vehicle (V2V) communication, or a Vehicle to everything (V2X).

The communication system in the embodiments of the present disclosure may be applied to a Carrier Aggregation (CA) scenario, and may also be applied to a Dual Connectivity (DC) scenario, a Standalone (SA) network layout scenario, or a Non-Standalone (NSA) network layout scenario.

The communication system of the present disclosure may further be applied to an unlicensed spectrum. The unlicensed spectrum may also be regarded as a shared spectrum. Alternatively, the communication system of the present disclosure may also be applied to a licensed spectrum, and the licensed spectrum may also be regarded as a non-shared spectrum.

The present disclosure describes various embodiments in combination with the network device and the terminal device.

For example, the terminal device according to the present disclosure may be any device or apparatus configured with a physical layer and a media access control layer.

For example, the terminal device according to the present disclosure may also be referred to as a User Equipment (UE), an access terminal, a subscriber unit, a subscriber station, a mobile station, a mobile station, a remote station, a remote terminal, a mobile device, a user terminal, a terminal, a wireless communication device, a user agent, or a user device, or the like.

For another example, the terminal device according to the present disclosure may be a station (ST) in the WLAN, a cellular phone, a cordless phone, a Session Initiation Protocol (SIP) phone, a Wireless Local Loop (WLL) station, a Personal Digital Assistant (PDA) device, a hand-held device having a wireless communication function, a computing device or another processing device connected to a wireless modem, an on-board device, a wearable device, a terminal device in the next generation communication system (such as the NR network), a terminal device in a Public Land Mobile Network (PLMN) in future evolution, or the like. The wearable device may also be referred to as the wearable smart device, and is a general term for intelligently designing for the daily wear and developing the device wearable (such as glasses, gloves, watches, clothing and shoes) by applying the wearable technology. The wearable device is a portable device that is worn directly on the body or integrated into the user's clothes or accessories. The wearable device is not just a hardware device, but may also be the function implemented through software support. Generalized wearable smart device includes following characteristics: comprehensive functions, large size, and all or part of functions may be implemented without relying on the smart phone, (for example, a smart watch or smart glasses), and other devices (such as a smart phone) are needed to be used in conjunction for a certain type of application functions only, for example, various types of smart bracelets and smart jewelry for monitoring the physical signs.

for another example, the terminal device according to the present disclosure may be a Mobile Phone, a tablet computer (Pad), a computer with a wireless transceiver function, a Virtual Reality (VR) terminal device, or an Augmented Reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city or a wireless terminal device in a smart home, etc.

It is to be noted that the terminal device according to the present disclosure can be deployed on land, including indoor or outdoor, hand-held, wearable or vehicle-mounted; and can also be deployed on the water surface (such as the ship, etc.); and can also be deployed in the air (such as the airplane, balloon and artificial satellite).

Exemplarily, the network device according to the present disclosure may be a device for communicating with the terminal device.

For example, the network device according to the present disclosure may provide the service for the cell. That is, the terminal device communicates with the network device through the transmission resource (for example, a frequency domain resource or a spectrum resource) used by the cell. The cell may be a cell corresponding to the network device (for example, a base station), and the cell may belong to a macro base station, or a base station corresponding to a Small cell. The Small cell may include: a Metro cell, a Micro cell, a Pico cell, a Femto cell, or the like. These Small cells have the characteristics of small coverage and low transmission power, and are suitable for providing high-speed data transmission services.

For example, the network device may be an Access Point (AP) in WLAN, a Base Transceiver Station (BTS) in GSM or CDMA, a NodeB (NB) in WCDMA, an evolutionary Node B (eNB or eNodeB) in LTE, or a relay station or an Access Point, or a vehicle-mounted device, a wearable device, a network device or a gNB in an NR network, or a network device in a future evolved PLMN network or a network device in an NTN network, or the like.

It is to be noted that the network device according to the present disclosure may have the mobile characteristic. For example, the network device may be a device mobile. Alternatively, the network device may be a satellite or a balloon station. For example, the satellite may be a low earth orbit (LEO) satellite, a medium earth orbit (MEO) satellite, a geostationary earth orbit (GEO) satellite, a High Elliptical Orbit (HEO) satellite, or the like. Alternatively, the network device may also be a base station installed on the land, in the water, or the like.

It is to be understood that the terms “system” and “network” in the present disclosure are often used interchangeably herein.

In order to facilitate the understanding of the solution provided in the present disclosure, the content related to the sidelink communication will be described below by way of example.

### 1. LTE D2D/V2X.

LTE D2D/V2X is a device-to-device Sidelink (SL) communication technology, which is different from the conventional cellular system in which the communication data is received or transmitted by the network device. Since the sidelink communication uses the terminal-to-terminal direct communication method, it has higher spectral efficiency and lower transmission delay.

Exemplarily, the LTE D2D/V2X may include the following two transmission modes: mode A and mode B.

Mode A: the transmission resource of the terminal is allocated by the network device, and the terminal transmits the data on the sidelink according to the resource allocated by the network device. For example, the network device may allocate the resource for a single transmission to the terminal, or may allocate the resource for a semi-static transmission to the terminal.

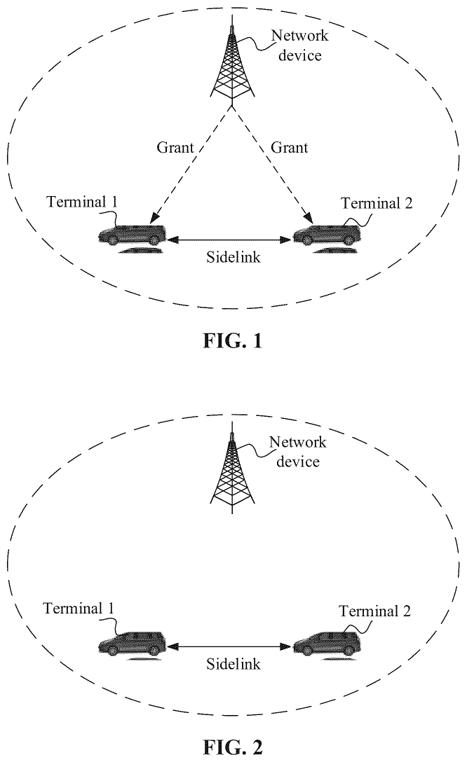

FIG. 1 is a schematic diagram of mode A according to the present disclosure.

As illustrated in FIG. 1, the terminal 1 and the terminal 2 are located within the coverage range of the network device, and the network device may allocate the transmission resources for the terminal 1 and the terminal 2, respectively. That is, the terminal 1 may transmit data on the sidelink according to the resource allocated by the network device for the terminal 1, and the terminal 2 may transmit data on the sidelink according to the resource allocated by the network device for the terminal 2.

Mode B: the terminal selects a resource in the resource pool for performing data transmission. For example, the terminal may independently select a transmission resource in the resource pool configured by the network to perform sidelink transmission, or may independently select a transmission resource in the pre-configured resource pool to perform sidelink transmission.

FIG. 2 is a schematic diagram of mode B according to the present disclosure.

As illustrated in FIG. 2, the terminal 1 and the terminal 2 are located within the coverage range of the network device, and the terminal 1 or the terminal 2 may select a resource in the resource pool to perform the data transmission.

For example, the LTE D2D/V2X may be classified into such as Proximity based Service (ProSe), Vehicle to everything (V2X), and FeD2D (Wearable Device) based on the application scenarios.

ProSe: it is mainly for the public safety service. In the ProSe, by configuring the position of the resource pool in the time domain, for example, the resource pool is discontinuous in the time domain, it may be implemented that the terminal transmits/receives the data discontinuously on the sidelink, thereby implementing the effect of power saving.

V2X: it is mainly oriented to the vehicle-to-vehicle and vehicle-person communication services with relatively high-speed movement. In the V2X, because the vehicle system has a continuous power supply, the power efficiency is not the main problem. However, the delay of data transmission is the main problem. Therefore, the system design requires the terminal device to perform the transmission and reception continuously.

FeD2D: it is mainly oriented to the scenario in which the wearable device accesses the network through the mobile phone, and mainly oriented to the scenario of low moving speed and low power access. In FeD2D, the base station may configure the Discontinuous Reception (DRX) parameter of the remote terminal through the relay terminal.

Exemplarily, the multi-carrier mechanism may also be introduced in LTE V2X.

Specifically, the multi-carrier mechanism is embodied in that the terminal can support the data packet division as well as transmitting the data packet with a plurality of carriers, thereby improving the data transmission rate. Accordingly, the receiving end may also receive the data packet by using a multi-carrier to implement the enhancement. For example, a same packet may be duplicated twice by means of packet duplication and be transmitted with two carriers to improve transmission reliability. Specifically, for the packet duplication: the V2X sidelink communication supports the sidelink packet duplication, and it is performed at a Packet Data Convergence Protocol (PDCP) layer of the UE. For the sidelink packet duplication, the PDCP Protocol Data Unit (PDU) is duplicated at the PDCP entity. The duplicate PDCP PDUs of the same PDCP entity are submitted to two different Radio Link Control (RLC) entities and associated with two different sidelink logical channels, respectively. The duplicate PDCP PDUs of the same PDCP entity are only allowed to be transmitted on different sidelink carriers. The terminal may activate or deactivate the sidelink packet duplication based on the (pre-) configuration. The sidelink packet duplication is not applicable to the transmission with a Rel-14 transmission profile (TS 23.285 [72]). The Prose Per-Packet Reliability (PPPR) value that supports the sidelink packet duplication may be (pre-) configured through the PPPR threshold. For UE-autonomous resource selection and the scheduled resource allocation, the UE shall perform sidelink packet duplication for data with the configured PPPR values until the sidelink packet duplication is stopped for these PPPR values. For the scheduled resource allocation, the UE reports the amount of data associated with one or more PPPR values and the destination to which the data belongs through the sidelink Buffer Status Report (BSR). The mapping of the PPPR value to the logical channel group may be configured by the eNB, and the PPPR value is reflected by the associated logical channel group ID included in the sidelink BSR. The list of one or more PPPR values may be reported in sidelink UE information by one Radio Resource Control (RRC) connected UE.

### 2. NR V2X.

On the basis of the LTE V2X, the NR V2X is not limited to the broadcast scenario, but further expanded to unicast and multicast scenarios.

That is, in LTE-V2X, the broadcast transmission manner is supported, and in NR-V2X, the unicast and multicast transmission manners are introduced.

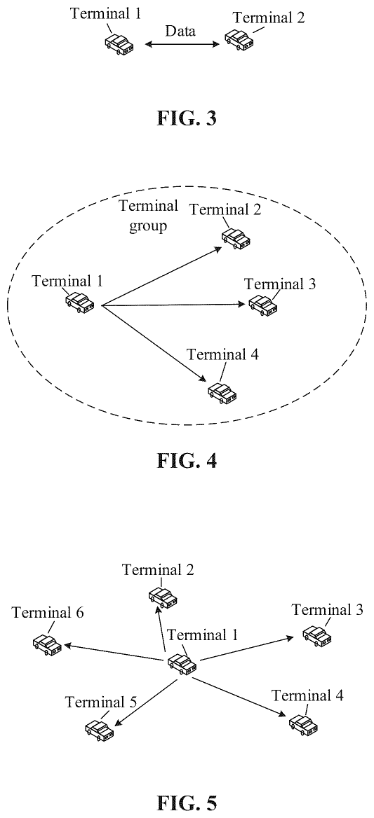

For the unicast transmission, there is only one terminal at the receiving end. FIG. 3 is a schematic diagram of the unicast transmission according to the present disclosure. As illustrated in FIG. 3, the unicast transmission is performed between the terminal 1 and the terminal 2. For the multicast transmission, the receiving end is all terminals in a communication group, or all terminals within a certain transmission distance. FIG. 4 is a schematic diagram of the multicast transmission according to the present disclosure. As illustrated in FIG. 4, the terminal 1, the terminal 2, the terminal 3, and the terminal 4 constitute a communication group. The terminal 1 transmits the data, and other terminal devices in the group are all receiving terminals. For the broadcast transmission manner, the receiving end is any terminal around the transmitting end terminal. FIG. 5 is a schematic diagram of the broadcast transmission according to the present disclosure. As illustrated in FIG. 5, the terminal 1 is a transmitting terminal, and other terminals around the terminal 1, i.e., the terminal 2 to the terminal 6, are all receiving terminals.

Similar to LTE V2X, the NR V2X may also define two resource grant modes, i.e., mode 1 and mode 2.

Further, the terminal may be in a mixed mode. That is, the terminal may use mode 1 to acquire the resource, meanwhile the terminal may also use mode 2 to acquire the resource. The resource acquisition is indicated by a sidelink grant. That is, the sidelink grant indicates the time-frequency positions of the corresponding Physical Sidelink Control Channel (PSCCH) and Physical Sidelink Shared Channel (PSSCH) resource.

Furthermore, same as LTE V2X, in NR V2X, because the vehicle system has a continuous power supply, the power efficiency is not the main problem. However, the delay of data transmission is the main problem. Therefore, the system design requires the terminal device to perform the transmission and receiving continuously.

In addition, in NR-V2X, the sidelink feedback channel is introduced to improve reliability.

For example, the sidelink feedback may be activated or deactivated by the pre-configuration information or the network configuration information, or the sidelink feedback may be activated or deactivated by the transmitting terminal. If the sidelink feedback is activated, the receiving end receives the sidelink data transmitted by the transmitting end, and feeds back ACK or NACK to the transmitting end according to the detection result. Accordingly, the transmitting terminal determines to transmit the retransmission data or new data based on the feedback information of the receiving terminal. If the sidelink feedback is deactivated, the receiving end does not need to transmit the feedback information, and the transmitting end generally transmits the data in a blind retransmission manner. For example, the transmitting end terminal repeatedly transmits each sidelink data K times instead of determining whether it is necessary to transmit the retransmission data according to the receiving end feedback information. The usage scenario of sidelink feedback is not limited to the unicast communication, but also includes the multicast communication.

FIG. 6 is a schematic diagram of the sidelink feedback according to the present disclosure.

As illustrated in FIG. 6, with respect to the unicast transmission, the transmitting end transmits the sidelink data (including a Physical Side-link Control Channel (PSCCH) and a Physical Side-link Shared Channel (PSSCH)) to the receiving end terminal, the receiving end terminal transmits the Hybrid Automatic Repeat reQuest (HARQ) feedback information (including an Acknowledgement (ACK) or a Negative Acknowledgement (NACK)) to the transmitting end terminal, and the transmitting end terminal determines whether the retransmission is required based on the feedback information of the receiving end terminal. The HARQ feedback information is carried in a sidelink feedback channel, such as the PSFCH.

Exemplarily, the terminal triggers a sidelink RRC reconfiguration procedure in the following scenarios:
releasing a sidelink data bearer in the unicast communication;
establishing a sidelink data bearer in the unicast communication;
modifying a configuration related to the sidelink data bearer in the unicast communication;
releasing a PC5 relay RLC channel between the relay terminal and the remote terminal in the terminal-to-network relay scenario;
establishing a PC5 relay RLC channel between the relay terminal and the remote terminal in the terminal-to-network relay scenario;
modifying the configuration parameter related to the PC5 relay RLC channel between the relay terminal and the remote terminal in the terminal-to-network relay scenario;
reconfiguration of the parameter related to the NR sidelink measurement reporting;
reconfiguration of the sidelink Channel State Information (CSI) reference signal resources and the CSI reporting delay boundary;
reconfiguration of the peer terminal sidelink DRX.

It is to be understood that the relay terminal according to the present disclosure may be implemented as a relay terminal of a layer 2 relay or a layer 3 relay.

The layer 2 uses the link of the layer 1 to complete the transmission of the application data of the layer 3. Layer 3 is used for delivering the control message. For example, layer 3 may include an Internet Protocol (IP) layer and a Radio Resource Control (RRC) layer, as well as a non-access layer (NAS). Layer 2 is used for providing the correct transmission and reception of the signaling message, and partial duplication detection. For example, layer 2 may include a Packet Data Convergence Protocol (PDCP) layer, a Radio Link Control (RLC) layer, a Media Access Control (MAC) layer, etc. Layer 1 is used for providing a transmission and reception wireless link between the base station and the terminal device. For example, layer 1 may include a Physical Layer.

The PDCP layer may be used for processing the RRC messages on the control plane and the Internet Protocol (IP) packet on the user plane. On the user plane, after the PDCP layer acquires the IP data packet from the upper layer, the header compression and encryption may be performed on the IP data packet, and then it is delivered to the RLC layer. The RLC layer may be used for providing the segmentation and retransmission service for the user and control data, and then it is delivered to the MAC layer. The function of the RLC layer may be implemented by an RLC entity, and one RLC entity may be configured into any one of the following three modes: Transparent Mode (TM), Unacknowledged Mode (UM), or Acknowledged Mode (AM). The AM mode provides all RLC functions, which can effectively improve the reliability of data transmission through error detection and retransmission. The MAC layer is mainly responsible for the mapping between the logical channel and the transport channel. When the data is transmitted, the MAC layer may determine in advance whether the data can be transmitted. If the data can be transmitted, some pieces of control information will be added to the data, and finally the data and the control information will be transmitted to the physical layer in a specified format. The physical layer is used for transmitting all information from the MAC transport channel through the air interface, and it is mainly responsible for: link adaptation (AMC) requiring care, power control, cell search (for the purpose of initial synchronization and handover), and other measurement values of the radio resource control layer.

### 3. Terminal-to-Network Relay.

For the terminal-to-network relay, the remote terminal accesses the network through a relay terminal with relay function, the remote terminal and the relay terminal are connected with each other through a sidelink, and the relay terminal transmits the data between the remote terminal and the network.

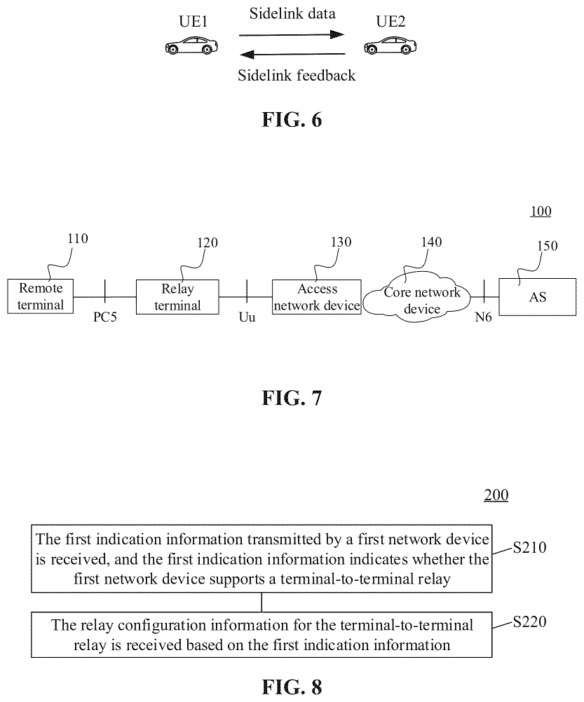

FIG. 7 is an example of a system framework 100 of terminal-to-network relay according to the present disclosure.

As illustrated in FIG. 7, the system framework 100 may include a remote terminal 110, a relay terminal 120, an access network device 130, a core network device 140, and an application server (AS) 150. The remote terminal 110 may be connected to the relay terminal 120 through the PC5 interface, and the relay terminal 120 may be connected with the access network device 130 through the Uu interface, thereby being connected to the core network device 140, and the core network device 140 may be connected to the AS 150 through the N6 interface.

The remote terminal 110 and the relay terminal 120 may be terminal devices that have been authenticated by the network when there is a network coverage. The remote terminal 110 may be a terminal device authenticated to be able to access the wireless network through the relay terminal. In other words, the remote terminal 110 may be authorized to be a remote UE. The relay terminal 120 may be a terminal device authenticated to operate as a relay node. Both the remote terminal 110 and the relay terminal 120 may be authorized to transmit and receive the message related to relay discovery, and the message related to relay discovery may include a discovery message and a discovery request message.

Before the data is transmitted, the remote terminal 110 needs to discover a suitable relay terminal (e.g., relay terminal 120) by using the discovery process and establish a PC5 connection with the relay terminal. After the discovery process, a PC5 connection is established between the relay terminal and the remote terminal. The relay discovery process may include a discovery process of mode A or mode B. In the discovery process of mode A, the relay terminal 120 actively broadcasts a relay service code (RSC) supported by the relay terminal 120, and the remote terminal 110 does not need to feedback a response message. The RSC may be used for determining that the relay terminal 120 is capable of providing the relay service. During the discovery process of mode B, the remote terminal 110 first broadcasts the RSC required by the remote terminal 110, and if there is a relay terminal (for example, the relay terminal 120) around that can support the RSC required by the remote terminal 110, the relay terminal (for example, the relay terminal 120) that can support the RSC required by the remote terminal 110 responds to the remote terminal 110 with a response message.

Exemplarily, the remote terminal 110 may support an end-to-end protocol stack, the end-to-end protocol stack may include a Packet Data Convergence Protocol (PDCP) layer of the 3GPP PC5 interface and an upper protocol layer above the PDCP layer, and the upper protocol layer may include a protocol layer of the user side and a protocol layer of the control side. The protocol layer of the user side include, but is not limited to, a Service Data Adaptation Protocol (SDAP) layer and an Internet Protocol (IP) layer, and the protocol layer of the control side include, but is not limited to, a Radio Resource Control (RRC) layer and a Non-Access Stratum (NAS). Further, the remote terminal 110 and the relay terminal 120 may support a point-to-point protocol stack, and the point-to-point protocol stack may include a layer 2 (L2) protocol stack and a layer 1 (L1) protocol stack of the 3GPP PC5 interface. Layer 2 protocol stack is used for providing the correct transmission and reception of the signaling message, and partial duplication detections. For example, layer 2 protocol stack may include a PDCP layer, an RLC layer, an MAC layer, etc. Layer 1 protocol stack is used for providing a transmission and reception wireless link between the base station and the terminal device. For example, layer 1 protocol stack may include a Physical Layer.

Further, the relay terminal 120 may be provided with a relay protocol layer. The function of the relay protocol layer may be used for transmitting the data packet and related control information between the remote terminals through the relay terminal.

Exemplarily, the relay protocol layer may be implemented as a terminal-to-network relay function relayed by layer 2, and the layer 2 is used for providing the correct transmission and reception of signaling message, including partial duplication detections. For example, the layer 2 may include a PDCP layer, an RLC layer, an MAC layer, etc. That is, the remote terminal accesses the network through a relay terminal with a layer 2 relay function, and the relay terminal carries the function below the Access Stratum (AS) and the RLC layer. The relay terminal with layer 2 relay function transmits data between the remote terminal and the network, and the remote terminal and the relay terminal are connected with each other via the sidelink.

Exemplarily, the relay protocol layer may be implemented as a terminal-to-network relay function relayed by layer 3, and the layer 3 is used for delivering the control message. For example, layer 3 may include an IP layer and an RRC layer, as well as an NAS. The remote terminal accesses the network through a relay terminal with a layer 3 relay function. For example, the relay terminal has the function of the IP layer relay. Specifically, the relay terminal with layer 3 relay function transmits the data between the remote terminal and the network, and the remote terminal and the relay terminal are connected with each other via the sidelink.

It is to be understood that the remote terminal 110 and the relay terminal 120 in the present disclosure may be the above-mentioned terminal device, the access network device 130 may be the above-mentioned network device, and the core network device 140 includes, but is not limited to, an Access and Mobility Management Function (AMF), an Authentication Server Function (AUSF), and a User Plane Function (UPF) Session Management Function (SMF). For example, the core network device 140 may be a 5G Core (5GC) device or an Evolved Packet Core (EPC) device of an LTE network. It is to be understood that in other alternative embodiments, a new network entity may be formed by dividing the network elements in the core network device 140, which is not limited in the embodiments of the present disclosure. Of course, the system framework 100 may also be applied to other 3GPP communication systems, such as a 4G communication system, or a future 3GPP communication system, and the AS 150 may also be another terminal device or an external public security Internet.

Exemplarily, the remote terminal 110 may be configured to measure the sidelink reporting information and report the information.

The sidelink reporting information may include the information such as an identifier of a relay terminal, an identifier of a serving cell, and a measurement value of a Reference Signal Receiving Power (RSRP). When the remote terminal 110 performs link switching from the indirect path to the direct path, the relay terminal preferentially uses the Sidelink Reference Signal Receiving Power (SL-RSRP) for performing the measurement on the sidelink. When the remote terminal performs link switching from the direct path to the indirect path, the measurement on the sidelink is preferentially performed by using the Sidelink Date Reference Signal Receiving Power (SD-RSRP). In addition, when the remote terminal 110 performs the measurement reporting, two new measurement reporting trigger events may be defined for the terminal-to-network relay handover. For the measurement reporting triggered based on the event 1, when the link quality of the relay terminal is lower than the configured threshold value, the remote terminal 110 performs the measurement reporting. For example, when the link quality of the relay terminal is lower than the configured threshold value and the link quality of the neighboring cell is higher than the configured threshold value, the remote terminal 110 performs the measurement reporting. For the measurement reporting triggered based on the event 2, when the link quality of the serving cell is lower than the configured threshold value, the remote terminal performs the measurement reporting. For example, when the link quality of the serving cell is lower than the configured threshold value and the link quality of the relay terminal is higher than the configured threshold value, the remote terminal 110 performs the measurement reporting.

For example, in order to assist the remote terminal to perform switching from the direct link to the indirect link, a new timer may also be introduced. When the remote terminal receives an RRC reconfiguration message indicating the switch from the direct link to the indirect link, the remote terminal turns on the timer. If the timer times out, the remote terminal performs RRC reestablishment.

For example, for the terminal-to-network relay, the system broadcast message transmitted by the network device may include a capability indication of layer 2 relay/layer 3 relay. Specifically, for the terminal-to-network relay, whether the network device supports layer 2 relay may be indicated by sl-L2U2N-Relay, whether the network device supports the terminal device to transmit the non-relay discovery message may be indicated by sl-NonRelayDiscovery, and whether the network device supports the terminal device to transmit the layer 3 relay or relay discovery message may be indicated by sl-L3U2N-RelayDiscovery. The format of the capability indication of Layer 2 Relay/Layer 3 Relay may be as follows:

| | | |
|---|---|---|
| SIB12-IEs-r16 ::= | SEQUENCE { | |
| sl-ConfigCommonNR-r16 | SL-ConfigCommonNR-r16, | |
| lateNonCriticalExtension | OCTET STRING | OPTIONAL, |
| ..., | | |
| [[ | | |
| sl-DRX-ConfigCommon-GC-BC-r17 | SL-DRX-Config-GC-BC-r17 | OPTIONAL, - |
| - Need R | | |
| sl-DiscConfigCommon-r17 | SL-DiscConfigCommon-r17 | OPTIONAL, -- |
| Need R | | |
| sl-L2U2N-Relay | ENUMERATED {support} | OPTIONAL, -- Need R |
| sl-NonRelayDiscovery | ENUMERATED {support} | OPTIONAL, -- Need R |
| sl-L3U2N-RelayDiscovery | ENUMERATED {support} | OPTIONAL -- Need |
| R | | |
| ]] | | |
| }. | | |

It is to be understood that for the terminal-to-terminal relay and the terminal-to-network relay, the source remote terminal accesses the target remote terminal through a relay terminal with relay function, the source remote terminal, the relay terminal and the target remote terminal are connected through the sidelink, and the relay terminal transmits the data between the source remote terminal and the target remote terminal. However, how the relay terminal and the remote terminal implement the terminal-to-terminal relay, for example, how the relay terminal and the remote terminal acquire the relay configuration information for the terminal-to-terminal relay, is a technical problem that needs to be solved urgently in the art.

In view of this, the present disclosure provides a method for acquiring configuration information acquisition, a method for forwarding configuration information, and a terminal device, such that the communication performance of terminal-to-terminal relay may be improved.

FIG. 8 is a schematic flowchart of the method 200 for acquiring configuration information according to the present disclosure. The method 200 for acquiring configuration information may be performed by the first terminal device. The first terminal device may be a remote terminal or a relay terminal. For example, the method 200 for acquiring configuration information may be performed by a remote terminal or a relay terminal for terminal-to-terminal communication.

As illustrated in FIG. 8, the method 200 for acquiring configuration information may include steps S210 to S220.

At S210, the first terminal device receives the first indication information transmitted by a first network device. The first indication information indicates whether the first network device supports a terminal-to-terminal relay.

For example, the first indication information indicating whether the first network device supports terminal-to-terminal relay may be understood as follows: the first indication information may indicate whether the first network device has the capability to configure the first terminal device to perform the terminal-to-terminal relay. That is, the first indication information may be used for instructing the first terminal device to acquire the relay configuration information used by the first terminal device for the terminal-to-terminal relay. For example, when the first indication information indicates that the first network device supports the terminal-to-terminal relay, the first instruction information indicates that the first terminal device obtains the relay configuration information from the first network device. For another example, when the first indication information indicates that the first network device does not support the terminal-to-terminal relay, the first indication information is used for instructing the first terminal device to acquire the relay configuration information from other devices (for example, a second terminal device which establishes a relay connection with the first terminal device) other than the first network device.

At S220, the terminal device obtains the relay configuration information for the terminal-to-terminal relay based on the first indication information.

For example, the relay configuration information may be layer 2 relay configuration information. That is, the relay configuration information may be used for the terminal-to-terminal relay of layer 2, and the layer 2 is used for providing the correct transmission and reception of the signaling message, including partial duplication detections. For example, the layer 2 may include a PDCP layer, an RLC layer, an MAC layer, etc. That is, the remote terminal accesses the network through a relay terminal with a layer 2 relay function, and the relay terminal carries the function below the Access Stratum (AS) and the RLC layer. The remote terminal (including the source remote terminal and the target remote terminal) and the relay terminal are connected via the sidelink, and the relay terminal with layer 2 relay function transmits the data between the source remote terminal and the target remote terminal.

For example, the relay configuration information may be layer 3 relay configuration information. That is, the relay configuration information may be used for the terminal-to-terminal relay of layer 3, and the layer 3 is used for transmitting the control information. For example, layer 3 may include an IP layer and an RRC layer, as well as an NAS. The remote terminal accesses the network through a relay terminal with a layer 3 relay function. For example, the relay terminal has the function of the IP layer relay. Specifically, the remote terminal (including the source remote terminal and the target remote terminal) and the relay terminal are connected via the sidelink, and the relay terminal with layer 3 relay function transmits the data between the source remote terminal and the target remote terminal.

Exemplarily, the relay configuration information may include the configuration information of the resource for terminal-to-terminal relay, for example, the configuration information of a resource pool for terminal-to-terminal relay. Of course, other configuration information for terminal-to-terminal relay may also be included, which is not specifically limited in the present disclosure.

In the embodiments of the present disclosure, the first indication information is introduced, and the first indication information is designed for indicating whether the first network device supports terminal-to-terminal relay. That is, the first indication information may indicate whether the first network device has the capability to configure the first terminal device to perform the terminal-to-terminal relay. In other words, the first indication information may be used for instructing the first terminal device to acquire the relay configuration information used by the first terminal device for the terminal-to-terminal relay.

In some embodiments, the first indication information indicates that the first network device supports the terminal-to-terminal relay. The step S220 may include following operation.

The relay configuration information is obtained from the first network device.

For example, when the first indication information indicates that the first network device supports terminal-to-terminal relay, it means that the first indication information indicates that the first network device has the capability to configure the first terminal device to perform the terminal-to-terminal relay. In this case, the first terminal device may obtain the relay configuration information used by the first terminal device for the terminal-to-terminal relay from the first network device.

In some embodiments, the first indication information indicates that the first network device does not support the terminal-to-terminal relay. The step S220 may include following operation.

The relay configuration information is obtained from a second terminal device which establishes a relay connection with the first terminal device.

For example, when the first indication information indicates that the first network device does not support terminal-to-terminal relay, it means that the first indication information indicates that the first network device does not have the capability to configure the first terminal device to perform the terminal-to-terminal relay. In this case, the first terminal device may obtain the relay configuration information used by the first terminal device for the terminal-to-terminal relay from other devices (for example, a second terminal device which establishes a relay connection with the first terminal device) other than the first network device.

In some embodiments, when the first indication information indicates that the first network device supports the terminal-to-terminal relay, the first indication information further indicates at least one of: a relay service type supported by the first network device, or a terminal type supported by the first network device for the terminal-to-terminal relay.

For example, when the first indication information indicates that the first network device supports the terminal-to-terminal relay, it means that the first indication information indicates that the first network device has the capability to configure the first terminal device to perform the terminal-to-terminal relay. In this case, the first indication information may further indicate a relay service type supported to be configured and a terminal type supported to be configured for the terminal-to-terminal relay. The relay service type supported by the first network device may be understood as the relay service type supported to be configured by the first network device. The terminal type supported by the first network device for the terminal-to-terminal relay may be understood as the terminal-to-terminal relay supported to be configured by the first network device.

In some embodiments, the terminal type of the first terminal device is a terminal type supported by the first network device for the terminal-to-terminal relay, and the type of relay service expected to be transmitted by the first terminal device is a relay service type supported by the first network device, and the S220 may include following operation.

The first terminal device obtains the relay configuration information from the first network device.

For example, if the terminal type of the first terminal device is a terminal type supported by the first network device for the terminal-to-terminal relay, and the type of relay service expected to be transmitted by the first terminal device is a relay service type supported by the first network device. It indicates that the first network device has the capability to configure the relay configuration information for the first terminal device. In this case, the first terminal device may obtain the relay configuration information from the first network device.

In some embodiments, the terminal type of the first terminal device is different from the terminal type supported by the first network device for the terminal-to-terminal relay, and/or the type of relay service expected to be transmitted by the first terminal device is different from the relay service type supported by the first network device. The step S220 may include following operation.

The first terminal device obtains the relay configuration information from a second terminal device which establishes a connection with the first terminal device.

For example, the terminal type of the first terminal device is different from the terminal type supported by the first network device for the terminal-to-terminal relay, and/or the type of relay service expected to be transmitted by the first terminal device is different from the relay service type supported by the first network device. It indicates that the first network device does not have the capability to configure the relay configuration information for the first terminal device. In this case, the first terminal device may obtain the relay configuration information from the second terminal device that established the connection with the first network device.

In some embodiments, the relay service type includes at least one of: a layer-2 terminal-to-terminal relay service, a layer-3 terminal-to-terminal relay service, a relay discovery service, or a non-relay discovery service.

For example, the layer 2 terminal-to-terminal relay service may refer to a service that uses Layer 2 to perform the terminal-to-terminal relay.

For example, the layer 3 terminal-to-terminal relay service may refer to a service that uses Layer 3 to perform the terminal-to-terminal relay.

For example, the relay discovery service may refer to a service for relay discovery, including, for example, but not limited to, transmitting and receiving a discovery message and a discovery request message for relay discovery.

For example, the non-relay discovery service may refer to a service that is not used for relay discovery, including, for example, but not limited to, transmitting and receiving a discovery message and a discovery request message that is not used for relay discovery.

In some embodiments, the relay discovery service includes at least one of: a layer 2 relay discovery service, or a layer 3 relay discovery service.

For example, the layer 2 relay discovery service may refer to a service for layer 2 relay discovery, including, for example, but not limited to, transmitting and receiving a discovery message and a discovery request message for layer 2 relay discovery.

For example, the layer 3 relay discovery service may refer to a service for layer 3 relay discovery, including, for example, but not limited to, transmitting and receiving a discovery message and a discovery request message for layer 3 relay discovery.

In some embodiments, the terminal type supported by the first network device for the terminal-to-terminal relay includes at least one of: a remote terminal, or a relay terminal.

For example, if the terminal type supported by the first network for the terminal-to-terminal relay is a remote terminal, when the first terminal device is a remote terminal, it indicates that the first network device has the capability to configure the relay configuration information for the first terminal device, and at this case, the first terminal device may obtain the relay configuration information from the first network device. If the terminal type supported by the first network for the terminal-to-terminal relay does not include a remote terminal, when the first terminal device is a remote terminal, it indicates that the first network device does not have the capability to configure the relay configuration information for the first terminal device, and at this case, the first terminal device may acquire the relay configuration information from the second terminal device that established the connection with the first terminal device.

For example, if the terminal type supported by the first network for the terminal-to-terminal relay is a relay terminal, when the first terminal device is a relay terminal, it indicates that the first network device has the capability to configure the relay configuration information for the first terminal device, and at this case, the first terminal device may obtain the relay configuration information from the first network device. If the terminal type supported by the first network for the terminal-to-terminal relay does not include a relay terminal, when the first terminal device is a relay terminal, it indicates that the first network device does not have the capability to configure the relay configuration information for the first terminal device, and at this case, the first terminal device may obtain the relay configuration information from the second terminal device that establishes the connection with the first terminal device.

In some embodiments, the remote terminal includes at least one of: a source remote terminal, or a target remote terminal.

In some embodiments, when the first terminal device obtains the relay configuration information from the second terminal device which establishes a relay connection with the first terminal device, the first terminal device may first transmit a first request to the second terminal device, and the first request is used for requesting to obtain the relay configuration information. Then the first terminal device receives the relay configuration information or a refusing response message transmitted by the second terminal device, and the refusing response message indicates that the second terminal device refuses to transmit the relay configuration information to the first terminal device.

For example, if the first indication information indicates that the first network device does not support the terminal-to-terminal relay, the first terminal device may first establish a relay connection with the second terminal device, and then transmits the first request to the second terminal device. Of course, the first terminal device may establish a relay connection with the second terminal device before receiving the first indication information. On the basis of the above, when the first terminal device receives the first indication information and the first indication information indicates that the first network device does not support the terminal-to-terminal relay, the first terminal device may transmits the first request to the second terminal device.

In some embodiments, the first request is carried in at least one of: PC5 Radio Resource Control (RRC) Message, PC5 Sidelink Message, Sidelink (SL) Media Access Control (MAC) Control Element (CE).

Exemplarily, the first request may be carried in a broadcast message, a unicast message, or a multicast message.

In some embodiments, the relay configuration information or the refusing response message is carried within at least one of the following messages: a PC5 RRC message, a PC5 sidelink message, and an SL MAC CE.

Exemplarily, the relay configuration information or the refusing response message may be carried in a broadcast message, a unicast message, or a multicast message.

In some embodiments, the first request includes a reason value indicating that the relay configuration information is requested.

For example, the reason value of the first request may indicate that the first terminal device cannot obtain the relay configuration information from the first network device to which the first terminal device belongs. Alternatively, the reason value of the first request may indicate that the first network device does not support the terminal-to-terminal relay. Alternatively, the reason value of the first request may indicate that the first network device does not have the capability to configure the relay configuration information for the first terminal device. Alternatively, the reason value of the first request may indicate that the first network device does not have the relay configuration information configured for a terminal device whose terminal type is the first terminal device. Alternatively, the reason value of the first request may indicate that the first network device does not have the capability to configure the relay configuration information for a relay service type whose relay service type is the relay service type of the first terminal device.

In some embodiments, the second terminal includes at least one of: a source remote terminal, a target remote terminal, or a relay terminal.

In some embodiments, the first terminal includes at least one of: a source remote terminal, a target remote terminal, or a relay terminal.

For example, if the second terminal device is a source remote terminal or a target remote terminal, the first terminal device is a relay terminal.

For example, if the second terminal device is a relay terminal, the first terminal device is a source remote terminal or a target remote terminal.

In some embodiments, the first terminal device is in an RRC idle state or an RRC inactive state, and the first terminal device may obtain the relay configuration information from a system message transmitted by the first network device.

In some embodiments, the first terminal device is in an RRC connected state, and the first terminal device may obtain the relay configuration information from the RRC configuration information transmitted by the first network device.

Exemplarily, the system message may be referred to as a broadcast message or System Information (SI).

Exemplarily, the system message includes, but is not limited to, a System Information Block (SIB), a Master Information Block (MIB), or a Remaining System Information (RMSI).

It is to be noted that the RRC state of the first terminal device may include an RRC inactive (RRC_INACTIVE) state, an RRC idle (RRC_IDLE) state, or an RRC connected (RRC_CONNECTED) state. RRC inactive may also be referred to as an RRC deactivated state.

For the RRC_CONNECTED state, there is an RRC connection between the first network device and the first terminal device, there is a UE Access Stratum (AS) context between the first network device and the first terminal device. That is, the first network device knows the location of the first terminal device at a specific cell level, the mobility of the first terminal device is controlled by the first network device, and the unicast data can be transmitted between the first network device and the first terminal device. For the RRC_IDLE state, there is no UE AS context and no RRC connection on the side of the first network device, the mobility of the first terminal device is implemented based on the cell selection/reselection, the paging of the first terminal device is initiated by the Core Network (CN), and the paging area thereof is configured by the CN. For the RRC_INACTIVE state, there is a connection between CN-NR, the UE AS context exists on a certain base station, the mobility of the first terminal device is implemented based on cell selection/reselection, the paging of the first terminal device is triggered by the Radio Access Network (RAN), the paging area thereof is managed by the RAN, and the first network device knows the location of the first terminal device based on the paging area level of the RAN.

Further, the first terminal device may switch or transition between various RRC states. For example, a UE in the RRC_CONNECTED state may enter the RRC_IDLE state by releasing the RRC connection. A UE in the RRC_IDLE state may enter the RRC_CONNECTED state by establishing an RRC connection. The UE in the RRC_CONNECTED state may enter the RRC_INACTIVE state by suspending the RRC connection. The UE in the RRC_CONNECTED state may enter the RRC_INACTIVE state by Release with Suspend RRC connection. The UE in the RRC_INACTIVE state may enter the RRC_CONNECTED state by resuming the RRC connection, or may, of course, enter the RRC_IDLE state by releasing the RRC connection.

In some embodiments, the first indication information includes a Boolean parameter.

Exemplarily, the value of the Boolean parameter includes only two values. One value may indicate that the condition is true, and the other value may indicate that the condition is not true. In combination with the present embodiment, one value may indicate that the first network device supports the terminal-to-terminal relay, and the other value may indicate that the first network device does not support the terminal-to-terminal relay.

In some embodiments, the method 200 further includes following operation.

The first terminal device receives the second indication information transmitted by the first network device. The second indication information indicates whether the first network device supports the first terminal to forward the relay configuration information to a peer terminal. In other words, the second instruction information indicates whether or not the first network device allows the first terminal device to forward the relay configuration information to the peer terminal.

Exemplarily, when the second indication information indicates that the first network device supports the first terminal device to forward the relay configuration information to a peer terminal, the first terminal device may forward the relay configuration information to a terminal device that establishes a relay connection with the first terminal device. When the second instruction information indicates that the first network device does not support the first terminal device to transmit the relay configuration information to the peer terminal, the first terminal device is prohibited from transmitting the relay configuration information to the terminal device that has established a relay connection with the first terminal device.

In some embodiments, the peer terminal includes at least one of: a relay terminal, or a remote terminal.

In some embodiments, the second indication information includes a Boolean parameter.

Exemplarily, the value of the Boolean parameter includes only two values. One value may indicate that the condition is true, and the other value may indicate that the condition is not true. In combination with the present embodiment, one value may indicate that the first network device supports the first terminal device to forward the relay configuration information to the peer terminal, and the other value may indicate that the first network device does not support the first terminal device to forward the relay configuration information to the peer terminal.

The preferred embodiments of the present disclosure have been described in detail with reference to the accompanying drawings. However, the present disclosure is not limited to the specific details in the above embodiments. Various simple modifications can be made to the technical solution of the present disclosure within the technical conception scope of the present disclosure, and these simple modifications all belong to the protection scope of the present disclosure. For example, each of the specific technical features as described in the above specific embodiments may be combined in any suitable manner without contradiction, and various possible combinations are not further described in the present disclosure in order to avoid unnecessary redundancy. For another example, any combination may be made between the various embodiments of the present disclosure, and the combination is likewise to be regarded as the disclosure of the present disclosure so long as it does not depart from the concept of the present disclosure.

It is further to be understood that, in various method embodiments of the present disclosure, the values of the sequence numbers of the above-described processes do not mean the sequence of execution, and the execution order of each process should be determined by its function and inherent logic, and should not limit the implementation of the embodiments of the present disclosure.

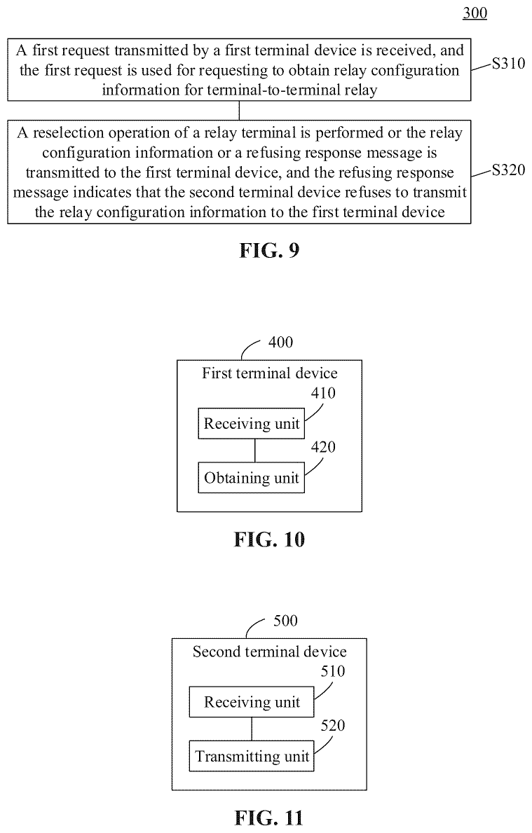

The method for acquiring configuration information according to the embodiment of the present disclosure has been described in detail above from the perspective of the first terminal device, and the method for forwarding configuration information according to the embodiment of the present disclosure will be described below from the perspective of the second terminal device with reference to FIG. 9.

FIG. 9 is a schematic flowchart of the method 300 for forwarding configuration information according to the present disclosure. The method 300 for forwarding configuration information may be performed by the second terminal device. The second terminal device may be a remote terminal or a relay terminal. For example, the method 300 for forwarding configuration information may be performed by a remote terminal or a relay terminal for terminal-to-terminal communication.

As illustrated in FIG. 9, the method 300 for forwarding configuration information may include steps S310 to S320.

At S310, the second terminal device receives a first request transmitted by a first terminal device. The first request is used for requesting to obtain relay configuration information for terminal-to-terminal relay.

At S320, the second terminal device performs a reselection operation of a relay terminal or transmits the relay configuration information or a refusing response message to the first terminal device. The refusing response message indicates that the second terminal device refuses to transmit the relay configuration information to the first terminal device.

In the present embodiment, by responding to the first request transmitted by the first terminal device, the second terminal device may be triggered to perform the reselection operation of the relay terminal of the second terminal device, or the second terminal device may be triggered to transmit the relay configuration information or the refusing response message to the first terminal device, such that the communication flow of the terminal-to-terminal relay may be improved, thereby improving the communication performance of the terminal-to-terminal relay.

In some embodiments, the relay configuration information or the refusing response message is carried within at least one of the following messages: a PC5 RRC message, a PC5 sidelink message, and an SL MAC CE.

Exemplarily, the relay configuration information or the refusing response message may be carried within a broadcast message, a unicast message, or a multicast message.

In some embodiments, the first terminal device is a relay terminal. Alternatively, when the first terminal device is not a relay terminal, the second terminal device transmits the relay configuration information or the refusing response message to the first terminal device.

For example, if the first terminal device is a relay terminal, the second terminal device performs a reselection operation of a relay terminal or transmits the relay configuration information or a refusing response message to the first terminal device. Otherwise, the second terminal device transmits the relay configuration information or the refusing response message to the first terminal device.

For example, if the first terminal device is a relay terminal, it indicates that the second terminal device may use the first terminal device as the relay terminal of the second terminal device, or may select another terminal device as the relay terminal of the second terminal device. If the other terminal device is selected as the relay terminal of the second terminal device, the reselection operation of the relay terminal may be performed. If the first terminal device is continuously used as the relay terminal of the second terminal device, the second terminal device may transmit the relay configuration information or a refusing response message to the first terminal device.

For example, if the first terminal device is a remote terminal, it indicates that the second terminal device is a relay terminal. In this case, the second terminal device may transmit the relay configuration information or the refusing response message to the first terminal device in order to cooperate with the relay communication of the first terminal device.

In some embodiments, before step S320, the method 300 may further include following operation.

The second terminal device receives the third indication information transmitted by the second network device. The third indication information indicates whether the second network device supports a terminal-to-terminal relay. Step S320 may include following operation.

The second terminal device transmits the relay configuration information or the refusing response message to the first terminal device based on the third indication information.

For example, the third indication information indicating whether the second network device supports the terminal-to-terminal relay may be understood as follows: the third indication information may indicate whether the second network device has the capability to configure the second terminal device to perform the terminal-to-terminal relay. That is, the third indication information may be used for instructing the second terminal device to obtain the relay configuration information used by the second terminal device for the terminal-to-terminal relay. For example, when the third indication information indicates that the second network device supports the terminal-to-terminal relay, the third instruction information indicates that the second terminal device obtains the relay configuration information from the second network device. For another example, when the third indication information indicates that the second network device does not support the terminal-to-terminal relay, the third indication information is used for instructing the second terminal device to obtain the relay configuration information from other devices (for example, a second terminal device that establishes a relay connection with the second terminal device) other than the first network device.

In some embodiments, the third indication information indicates that the second network device supports the terminal-to-terminal relay, and the second terminal device transmits the relay configuration information to the first terminal device.

For example, when the third indication information indicates that the second network device supports the terminal-to-terminal relay, it indicates that the third indication information indicates that the second network device has the capability to configure the second terminal device to perform the terminal-to-terminal relay. In this case, the second terminal device may obtain the relay configuration information from the second network device and forward the relay configuration information to the first terminal device.

In some embodiments, if the third indication information indicates that the second network device does not support the terminal-to-terminal relay, the second terminal device transmits the refusing response message to the first terminal device.

For example, when the third indication information indicates that the second network device does not support the terminal-to-terminal relay, it means that the third indication information indicates that the second network device does not have the capability to configure the second terminal device to perform the terminal-to-terminal relay. In this case, the second terminal device may directly transmit the refusing response message to the first terminal device.

In some embodiments, when the third indication information indicates that the second network device supports the terminal-to-terminal relay, the third indication information further indicates at least one of: a relay service type supported by the second network device, or a terminal type supported by the second network device for the terminal-to-terminal relay.

For example, when the third indication information indicates that the second network device supports the terminal-to-terminal relay, it means that the third indication information indicates that the second network device has the capability to configure the second terminal device to perform the terminal-to-terminal relay. In this case, the third indication information may further indicate a relay service type supported to be configured and a terminal type supported to be configured for the terminal-to-terminal relay. The relay service type supported by the second network device may be understood as the relay service type supported to be configured by the second network device. The terminal type supported by the second network device for the terminal-to-terminal relay may be understood as the terminal type supported to be configured by the first network device for the terminal-to-terminal relay.

In some embodiments, the terminal type of the first terminal device is a terminal type supported by the second network device for the terminal-to-terminal relay, and the type of relay service expected to be transmitted by the first terminal device is a relay service type supported by the second network device. The second terminal device transmits the relay configuration information to the first terminal device.

For example, if the terminal type of the first terminal device is a terminal type supported by the second network device for the terminal-to-terminal relay, and the type of relay service expected to be transmitted by the first terminal device is a relay service type supported by the second network device, it indicates that the second network device has the capability to configure the relay configuration information for the first terminal device. In this case, the second terminal device may obtain the relay configuration information from the first network device and forward the relay configuration information to the first terminal device.

In some embodiments, the terminal type of the first terminal device is different from the terminal type supported by the second network device for the terminal-to-terminal relay, and the type of relay service expected to be transmitted by the first terminal device is different from the relay service type supported by the second network device. The second terminal device transmits the refusing response message to the first terminal device.

For example, the terminal type of the first terminal device is different from the terminal type supported by the second network device for the terminal-to-terminal relay, and the type of relay service expected to be transmitted by the first terminal device is different from the relay service type supported by the second network device. It indicates that the second network device does not have the capability to configure the relay configuration information for the first terminal device. In this case, the second terminal device may directly transmit the refusing response message to the first terminal device.

In some embodiments, the relay service type includes at least one of: a layer-2 terminal-to-terminal relay service, a layer-3 terminal-to-terminal relay service, a relay discovery service, or a non-relay discovery service.

For example, the layer 2 terminal-to-terminal relay service may refer to a service that uses Layer 2 to perform the terminal-to-terminal relay.

For example, the layer 3 terminal-to-terminal relay service may refer to a service that uses Layer 3 to perform the terminal-to-terminal relay.

For example, the relay discovery service may refer to a service for relay discovery, including, for example, but not limited to, transmitting and receiving a discovery message and a discovery request message for relay discovery.

For example, the non-relay discovery service may refer to a service that is not used for relay discovery, including, for example, but not limited to, transmitting and receiving a discovery message and a discovery request message that is not used for relay discovery.

In some embodiments, the relay discovery service includes at least one of: a layer 2 relay discovery service, or a layer 3 relay discovery service.

For example, the layer 2 relay discovery service may refer to a service for layer 2 relay discovery, including, for example, but not limited to, transmitting and receiving a discovery message and a discovery request message for layer 2 relay discovery.

For example, the layer 3 relay discovery service may refer to a service for layer 3 relay discovery, including, for example, but not limited to, transmitting and receiving a discovery message and a discovery request message for layer 3 relay discovery.

In some embodiments, the terminal type supported by the second network device for the terminal-to-terminal relay includes at least one of: a remote terminal, or a relay terminal.

For example, if the terminal type supported by the second network for the terminal-to-terminal relay is a remote terminal, when the first terminal device is a remote terminal, it indicates that the second network device has the capability to configure the relay configuration information for the first terminal device, and at this case, the second terminal device may obtain the relay configuration information from the second network device and forward the relay configuration information to the first terminal device. If the terminal type supported by the second network for the terminal-to-terminal relay does not include a remote terminal, when the first terminal device is a remote terminal, it indicates that the second network device does not have the capability to configure the relay configuration information for the first terminal device, and at this case, the second terminal device may directly transmit the refusing response message to the first terminal device.

For example, if the terminal type supported by the second network for the terminal-to-terminal relay is a relay terminal, when the first terminal device is a relay terminal, it indicates that the second network device has the capability to configure the relay configuration information for the first terminal device, and at this case, the second terminal device may obtain the relay configuration information from the second network device and forward the relay configuration information to the first terminal device. If the terminal type supported by the second network for the terminal-to-terminal relay does not include a relay terminal, when the first terminal device is a relay terminal, it indicates that the second network device does not have the capability to configure the relay configuration information for the first terminal device, and at this case, the second terminal device may directly transmits the refusing response message to the first terminal device.

In some embodiments, the remote terminal includes at least one of: a source remote terminal, or a target remote terminal.

In some embodiments, before S320, the method 300 may further include following operation.

The second terminal device obtains the fourth indication information transmitted by the second network device. The fourth indication information indicates whether the second network device supports the second terminal to forward the relay configuration information to a peer terminal. Step S320 may include following operation.

The second terminal device transmits the relay configuration information or the refusing response message to the first terminal device based on the fourth indication information.

In other words, the fourth indication information indicates whether or not the second network device allows the second terminal device to forward the relay configuration information to the peer terminal.

In some embodiments, when the fourth indication information indicates that the second network device supports the second terminal device to forward the relay configuration information to a peer terminal, the second terminal device forwards the relay configuration information to the first terminal device. When the fourth indication information indicates that the second network device does not support the second terminal device to forward the relay configuration information to the peer terminal, the second terminal device transmits the refusing response message to the first terminal device.

For example, when the fourth indication information indicates that the second network device supports the second terminal device to forward the relay configuration information to the peer terminal, it indicates that the second network device has the capability to configure the terminal-to-terminal relay to other terminals (for example, the first terminal device) through the second terminal device. In this case, the second terminal device may obtain the relay configuration information from the second network device and forward the relay configuration information to the first terminal device.

Of course, in other alternative embodiments, the second terminal device may transmit the relay configuration information or the refusing response message to the first terminal device based on the third indication information and the fourth indication information described above.

For example, when the third indication information indicates that the second network device supports the terminal-to-terminal relay, and the fourth indication information indicates that the second network device supports the second terminal device to forward the relay configuration information to the peer terminal, the second terminal device forward the relay configuration information to the first terminal device. For another example, when the third indication information indicates that the second network device does not support the terminal-to-terminal relay, and/or the fourth indication information indicates that the second network does not support the second terminal device to forward the relay configuration information to the peer terminal, the second terminal device transmits the refusing response message to the first terminal device.

For example, when the third indication information indicates that the second network device supports the terminal-to-terminal relay, the third indication information further indicates at least one of: a relay service type supported by the second network device, or a terminal type supported by the second network device for the terminal-to-terminal relay. In this case, the second terminal device transmits the relay configuration information to the first terminal device when the following conditions are satisfied: the terminal type of the first terminal device is the terminal type supported by the second network device for the terminal-to-terminal relay, the type of relay service that the first terminal device expects to transmit is the relay service type supported by the second network device, and the fourth indication information indicates the second network device to support the second terminal device to forward the relay configuration information to the peer terminal. The second terminal device transmits the refusing response message to the first terminal device when at least one of the following conditions is satisfied: the terminal type of the first terminal device is different from the terminal type supported by the second network device for the terminal-to-terminal relay, the type of relay service that the first terminal device expects to transmit is different from the relay service type supported by the second network device, or the fourth indication information indicates that the second network device does not support the second terminal device to forward the relay configuration information to the peer terminal.

In some embodiments, the second terminal device is in an RRC idle state or an RRC inactive state, and the second terminal device obtains the fourth indication information from the system message transmitted by the second network device.

In some embodiments, the second terminal device is in an RRC connected state, and the second terminal device obtains the fourth indication information by transmitting the request message to the second network device.

In some embodiments, the second terminal device is in an RRC idle state or an RRC inactive state, and the relay configuration information is carried in a system message transmitted by a second network device to which the second terminal device belongs; or the second terminal device is in an RRC connected state, and the relay configuration information is carried in an RRC configuration information transmitted by the second network device.

Exemplarily, the system message may be referred to as a broadcast message or System Information (SI).

Exemplarily, the system message includes, but is not limited to, a System Information Block (SIB), a Master Information Block (MIB), or a Remaining System Information (RMSI).

It is to be noted that the RRC state of the second terminal device may include an RRC inactive (RRC_INACTIVE) state, an RRC idle (RRC_IDLE) state, or an RRC connected (RRC_CONNECTED) state. RRC inactive may also be referred to as an RRC deactivated state.

For the RRC_CONNECTED state, there is an RRC connection between the second network device and the second terminal device, there is a UE Access Stratum (AS) context between the second network device and the second terminal device. That is, the second network device knows the location of the second terminal device at a specific cell level, the mobility of the second terminal device is controlled by the second network device, and the unicast data can be transmitted between the second network device and the second terminal device. For the RRC_IDLE state, there is no UE AS context and no RRC connection on the side of the second network device, the mobility of the second terminal device is implemented based on the cell selection/reselection, the paging of the second terminal device is initiated by the Core Network (CN), and the paging area thereof is configured by the CN. For the RRC_INACTIVE state, there is a connection between CN-NR, the UE AS context exists on a certain base station, the mobility of the second terminal device is implemented based on cell selection/reselection, the paging of the second terminal device is triggered by the RAN, the paging area thereof is managed by the RAN, and the second network device knows the location of the second terminal device based on the paging area level of the RAN.

Further, the second terminal device may switch or transition between various RRC states. For example, a UE in the RRC_CONNECTED state may enter the RRC_IDLE state by releasing the RRC connection. A UE in the RRC_IDLE state may enter the RRC_CONNECTED state by establishing an RRC connection. The UE in the RRC_CONNECTED state may enter the RRC_INACTIVE state by suspending the RRC connection. The UE in the RRC_CONNECTED state may enter the RRC_INACTIVE state by Release with Suspend RRC connection. A UE in the RRC_INACTIVE state may enter the RRC_CONNECTED state by resuming the RRC connection, or may, of course, enter the RRC_IDLE state by releasing the RRC connection.

In some embodiments, the first request is carried in at least one of: a PC5 RRC message, a PC5 sidelink message, or an SL-MAC CE.

In some embodiments, the first request includes a reason value indicating that the relay configuration information is requested.

For example, the reason value of the first request may indicate that the first terminal device cannot obtain the relay configuration information from the first network device to which the first terminal device belongs. Alternatively, the reason value of the first request may indicate that the first network device does not support the terminal-to-terminal relay. Alternatively, the reason value of the first request may indicate that the first network device does not have the capability to configure the relay configuration information for the first terminal device. Alternatively, the reason value of the first request may indicate that the first network device does not have the relay configuration information configured for a terminal device whose terminal type is the first terminal device. Alternatively, the reason value of the first request may indicate that the first network device does not have the capability to configure the relay configuration information for a relay service type whose relay service type is the relay service type of the first terminal device.

In some embodiments, the second terminal includes at least one of: a source remote terminal, a target remote terminal, or a relay terminal.

In some embodiments, the first terminal includes at least one of: a source remote terminal, a target remote terminal, or a relay terminal.

For example, if the second terminal device is a source remote terminal or a target remote terminal, the first terminal device is a relay terminal.

For example, if the second terminal device is a relay terminal, the first terminal device is a source remote terminal or a target remote terminal.

It is to be understood that the steps in the method 300 for forwarding configuration information may refer to the corresponding steps in the method 200 for acquiring configuration information, and will not be elaborated herein for the sake of brevity.

The method embodiments of the present disclosure are described in detail above with reference to FIG. 1 to FIG. 9 and the device embodiments of the present disclosure are described in detail below with reference to FIG. 10 and FIG. 13.

FIG. 10 is a schematic block diagram of a first terminal device 400 according to the present disclosure.

As illustrated in FIG. 10, the first terminal device 400 may include a receiving unit 410 and an obtaining unit 420.

The receiving unit 410 is configured to receive first indication information transmitted by a first network device. The first indication information indicates whether the first network device supports a terminal-to-terminal relay.

The obtaining unit 420 is configured to obtain relay configuration information for the terminal-to-terminal relay based on the first indication information.

In some embodiments, the first indication information indicates that the first network device supports the terminal-to-terminal relay.

The obtaining unit 420 is specifically configured to:
obtain the relay configuration information from the first network device.

In some embodiments, the first indication information indicates that the first network device does not support the terminal-to-terminal relay.

The obtaining unit 420 is specifically configured to:
obtain the relay configuration information from a second terminal device which establishes a relay connection with the first terminal device.

In some embodiments, when the first indication information indicates that the first network device supports the terminal-to-terminal relay, the first indication information further indicates at least one of: a relay service type supported by the first network device, or a terminal type supported by the first network device for the terminal-to-terminal relay.

In some embodiments, the terminal type of the first terminal device is a terminal type supported by the first network device for the terminal-to-terminal relay, and the type of relay service expected to be transmitted by the first terminal device is a relay service type supported by the first network device.

The obtaining unit 420 is specifically configured to:
obtain the relay configuration information from the first network device.

In some embodiments, the terminal type of the first terminal device is different from the terminal type supported by the first network device for the terminal-to-terminal relay, and/or the type of relay service expected to be transmitted by the first terminal device is different from the relay service type supported by the first network device.

The obtaining unit 420 is specifically configured to:
obtain the relay configuration information from a second terminal device which establishes a connection with the first terminal device.

In some embodiments, the relay service type includes at least one of: a layer-2 terminal-to-terminal relay service, a layer-3 terminal-to-terminal relay service, a relay discovery service, or a non-relay discovery service.

In some embodiments, the relay discovery service includes at least one of: a layer 2 relay discovery service, or a layer 3 relay discovery service.

In some embodiments, the terminal type supported by the first network device for the terminal-to-terminal relay includes at least one of: a remote terminal, or a relay terminal.

In some embodiments, the remote terminal includes at least one of: a source remote terminal, or a target remote terminal.

In some embodiments, the obtaining unit 420 is specifically configured to:
transmit the first request to the second terminal device. The first request is used for requesting to obtain the relay configuration information.

The relay configuration information or a refusing response message transmitted by the second terminal device is received. The refusing response message indicates that the second terminal device refuses to transmit the relay configuration information to the first terminal device.

In some embodiments, the first request is carried in at least one of: a PC5 RRC message, a PC5 sidelink message, or an SL-MAC CE.

In some embodiments, the first request includes a reason value indicating that the relay configuration information is requested.

In some embodiments, when the first terminal device is a source remote terminal or a target remote terminal, the second terminal device is a relay terminal. When the first terminal device is a relay terminal, the second terminal device is a source remote terminal or a target remote terminal.

In some embodiments, the first terminal device is in an RRC idle state or an RRC inactive state.

The obtaining unit 420 is specifically configured to:
obtain the relay configuration information from a system message transmitted by the first network device.

In some embodiments, the first terminal device is in an RRC connected state.

The obtaining unit 420 is specifically configured to:
obtain the relay configuration information from the RRC configuration information transmitted by the first network device.

In some embodiments, the first indication information includes a Boolean parameter.

In some embodiments, the receiving unit 410 is further configured to:
receive the second indication information transmitted by the first network device. The second indication information indicates whether the first network device supports the first terminal to forward the relay configuration information to a peer terminal.

In some embodiments, the peer terminal includes at least one of: a relay terminal, or a remote terminal.

In some embodiments, the second indication information includes a Boolean parameter.

It is to be understood that device embodiments and method embodiments may correspond to each other and similar descriptions may refer to the method embodiments. Specifically, the first terminal device 400 illustrated in FIG. 10 may correspond to the corresponding entity in the method 200 according to the embodiments of the present disclosure, and the foregoing and other operations and/or functions of various units of the first terminal device 400 are to implement the corresponding flows in various methods according to the embodiments of the present disclosure, respectively, and will not elaborated here for the sake of brevity.

FIG. 11 is a schematic block diagram of a second terminal device 500 according to the present disclosure.

As illustrated in FIG. 11, the second terminal device 500 may include a receiving unit 510 and a transmitting unit 520.

The receiving unit 510 is configured to receive a first request transmitted by a first terminal device, wherein the first request is used for requesting to obtain relay configuration information for terminal-to-terminal relay.

The transmitting unit 520 is configured to perform a reselection operation of a relay terminal or transmit the relay configuration information or a refusing response message to the first terminal device. The refusing response message indicates that the second terminal device refuses to transmit the relay configuration information to the first terminal device.

In some embodiments, the first terminal device is a relay terminal.

Alternatively, when the first terminal device is not a relay terminal, the second terminal device transmits the relay configuration information or the refusing response message to the first terminal device.

In some embodiments, before the transmitting unit 520 transmits the relay configuration information or the refusing response message to the first terminal device, the receiving unit 510 is further configured to:
receive third indication information transmitted by a second network device, wherein the third indication information indicates whether the second network device supports a terminal-to-terminal relay.

The transmitting unit 520 is specifically configured to:
transmit the relay configuration information or the refusing response message to the first terminal device based on the third indication information.

In some embodiments, the third indication information indicates that the second network device supports the terminal-to-terminal relay.

The transmitting unit 520 is specifically configured to:
transmit the relay configuration information to the first terminal device.

In some embodiments, the third indication information indicates that the second network device does not support the terminal-to-terminal relay.

The transmitting unit 520 is specifically configured to:
transmit the refusing response message to the first terminal device.

In some embodiments, when the third indication information indicates that the second network device supports the terminal-to-terminal relay, the third indication information further indicates at least one of: a relay service type supported by the second network device, or a terminal type supported by the second network device for the terminal-to-terminal relay.

In some embodiments, the terminal type of the first terminal device is a terminal type supported by the second network device for the terminal-to-terminal relay, and the type of relay service expected to be transmitted by the first terminal device is a relay service type supported by the second network device.

The transmitting unit 520 is specifically configured to:
transmit the relay configuration information to the first terminal device.

In some embodiments, the terminal type of the first terminal device is different from the terminal type supported by the second network device for the terminal-to-terminal relay, and the type of relay service expected to be transmitted by the first terminal device is different from the relay service type supported by the second network device.

The transmitting unit 520 is specifically configured to:
transmit the refusing response message to the first terminal device.

In some embodiments, the relay service type includes at least one of: a layer-2 terminal-to-terminal relay service, a layer-3 terminal-to-terminal relay service, a relay discovery service, or a non-relay discovery service.

In some embodiments, the relay discovery service includes at least one of: a layer 2 relay discovery service, or a layer 3 relay discovery service.

In some embodiments, the terminal type supported by the second network device for the terminal-to-terminal relay includes at least one of: a remote terminal, or a relay terminal.

In some embodiments, the remote terminal includes at least one of: a source remote terminal, or a target remote terminal.

In some embodiments, before the transmitting unit 520 transmits the relay configuration information or the refusing response message to the first terminal device, the receiving unit 510 is further configured to:
obtain the fourth indication information transmitted by the second network device. The fourth indication information indicates whether the second network device supports the second terminal to forward the relay configuration information to a peer terminal.

The transmitting unit 520 is specifically configured to:
transmit the relay configuration information or the refusing response message to the first terminal device based on the fourth indication information.

In some embodiments, when the fourth indication information indicates that the second network device supports the second terminal device to forward the relay configuration information to a peer terminal, the second terminal device forwards the relay configuration information to the first terminal device. When the fourth indication information indicates that the second network device does not support the second terminal device to forward the relay configuration information to the peer terminal, the second terminal device transmits the refusing response message to the first terminal device.

In some embodiments, the second terminal device is in an RRC connected state.

The transmitting unit 520 is specifically configured to:
obtain the fourth indication information from a system message transmitted by the second network device.

In some embodiments, the second terminal device is in an RRC idle state or an RRC inactive state.

The transmitting unit 520 is specifically configured to:
obtain the fourth indication information by transmitting a request information to the second network device.

In some embodiments, the second terminal device is in an RRC idle state or an RRC inactive state, and the relay configuration information is carried in a system message transmitted by a second network device to which the second terminal device belongs; or the second terminal device is in an RRC connected state, and the relay configuration information is carried in an RRC configuration information transmitted by the second network device.

In some embodiments, the first request is carried in at least one of: a PC5 RRC message, a PC5 sidelink message, or an SL-MAC CE.

In some embodiments, the first request includes a reason value indicating that the relay configuration information is requested.

In some embodiments, when the first terminal device is a source remote terminal or a target remote terminal, the second terminal device is a relay terminal. When the first terminal device is a relay terminal, the second terminal device is a source remote terminal or a target remote terminal.

It is to be understood that device embodiments and method embodiments may correspond to each other and similar descriptions may refer to the method embodiments. Specifically, the second terminal device 500 illustrated in FIG. 11 may correspond to the corresponding entity in the method 300 according to the embodiments of the present disclosure, and the foregoing and other operations and/or functions of various units of the second terminal device 500 are to implement the corresponding flows in various methods according to the embodiments of the present disclosure, respectively, and will not elaborated here for the sake of brevity.

The communication device according to the embodiments of the present disclosure is described above from the perspective of the functional modules with reference to the accompanying drawings. It is to be understood that the functional modules may be implemented in hardware form, by the instructions in software form, or by a combination of hardware and software modules. In particular, each step of the method embodiments of the present disclosure can be completed by the integrated logic circuit of the hardware in the processor and/or the instruction in the form of software, and the steps of the method disclosed in combination with the embodiments of the present disclosure can be directly embodied as being performed by the hardware decoding processor or performed by the combination of the hardware and software modules in the decoding processor. Alternatively, the software module can be located in random memory, flash memory, read-only memory, programmable read-only memory, electrically erasable programmable memory, register or other mature storage media in the art. The storage medium is located in the memory, and the processor reads the information from the memory and completes the steps of the above method embodiments in combination with its hardware.

For example, the above-mentioned receiving unit and the transmitting unit may be implemented by the transceiver, and the above-mentioned obtaining unit may be implemented by the processor.

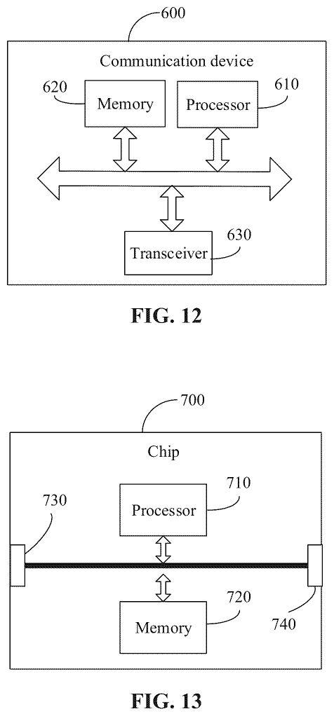

FIG. 12 is a schematic structural diagram of a communication device 600 according to an embodiment of the present disclosure.

As illustrated in FIG. 12, the communication device 600 may include a processor 610.

The processor 610 may call and run the computer program from the memory to implement the method in the embodiments of the disclosure.

As illustrated in FIG. 12, the communication device 600 may further include a memory 620.

The memory 620 may be used for storing the indication information, and may also be used for storing the code, instructions, or the like performed by the processor 610. The processor 610 can call and run the computer program from memory 620 to implement the method in the embodiments of the disclosure. The memory 620 may be a separate device independent of or integrated into the processor 610.

As illustrated in FIG. 12, the communication device 600 may further include a transceiver 630.

The processor 610 may control the transceiver 630 to communicate with other devices, particularly, to transmit information or data to other devices or receive information or data transmitted by other devices. The transceiver 630 may include a transmitter and a receiver. The transceiver 630 may further include an antenna, and the number of the antennas may be one or more.

It is to be understood that the various components in the communication device 600 are connected through a bus system, and the bus system includes a power bus, a control bus and a status signal bus in addition to a data bus.

It is also to be understood that the communication device 600 may be the first terminal device in the embodiments of the present disclosure, and the communication device 600 may implement the corresponding processes implemented by the first terminal device in various methods according to the embodiments of the present disclosure. That is, the communication device 600 in the embodiments of the present disclosure may correspond to the first terminal device 400 in the embodiments of the present disclosure, and may correspond to the corresponding entity performing the method 200 of the embodiments of the present disclosure, and it will not be elaborated here for the sake of brevity. Similarly, the communication device 600 may be the second terminal device in the embodiments of the present disclosure, and the communication device 600 may implement the corresponding processes implemented by the second terminal device in the methods of the embodiments of the disclosure. That is, the communication device 600 according to the embodiments of the present disclosure may correspond to the second terminal device 500 in the embodiments of the present disclosure, and may correspond to the corresponding entity performing the method 300 according to the embodiments of the present disclosure, and the description thereof will not be elaborated here for the sake of brevity.

Further, there is also provided a chip in the embodiments of the present disclosure.

For example, the chip may be an integrated circuit chip having signal processing capability, and the chip may implement or perform the methods, steps, and logic block diagrams disclosed in the embodiments of the present disclosure. The chip may also be referred to as a system-on-chip, a system chip, chip system or an SoC chip. Optionally, the chip may be applied to various communication devices, such that the communication device installed with the chip can perform the methods, steps, and logic block diagrams disclosed in the embodiments of the present disclosure.

FIG. 13 is a schematic structural diagram of a chip 700 according to an embodiment of the present disclosure.

As illustrated in FIG. 13, the chip 700 includes a processor 710.

The processor 710 may call and run the computer program from the memory to implement the method in the embodiments of the disclosure.

As illustrated in FIG. 13, the chip 700 may further include a memory 720.

The processor 710 can call and run the computer program from memory 720 to implement the method in the embodiments of the disclosure. The memory 720 may be used for storing the indication information, and may also be used for storing the code, instructions, or the like performed by the processor 710. The memory 720 may be a separate device independent of or integrated into the processor 710.

As illustrated in FIG. 13, the chip 700 may further include an input interface 730.

The processor 710 can control the input interface 730 to communicate with other devices or chips, and in particular can obtain information or data sent by other devices or chips.

As illustrated in FIG. 13, the chip 700 may further include an output interface 740.

The processor 710 may control the output interface 740 to communicate with other devices or chips, and in particular may output information or data to other devices or chips.

It is to be understood that the chip 700 can be applied to the first terminal device or the second terminal device in the embodiments of the present disclosure, and the chip can implement the corresponding processes implemented by the first terminal device or the second terminal device in various methods in the embodiments of the disclosure. For the sake of simplicity, it will not be described here.

It is further to be understood that the various components in the chip 700 are connected through a bus system, and the bus system includes a power bus, a control bus and a status signal bus in addition to a data bus.

The above-mentioned processor may include, but are not limited to, a general purpose processor, a digital signal processor (DSP), an application specific integrated circuit (ASIC), a field programmable gate array (FPGA) or other programmable logic devices, discrete element gate or transistor logic device, and discrete hardware component, etc.

The processor may be configured to implement or perform the methods, steps and logic block diagrams disclosed in the embodiments of the present disclosure. The steps of the method disclosed in combination with the embodiments of the present disclosure can be directly embodied as being performed and completed by the hardware decoding processor, or by the combination of the hardware and software modules in the coding processor. The software module can be located in the random memory, flash memory, read-only memory, programmable read-only memory or erasable programmable memory, register and other mature storage media in the art. The storage medium is located in the memory, and the processor reads the information from the memory and completes the steps of the above methods in combination with its hardware.

The above-mentioned memory may include, but are not limited to,
volatile memory and/or nonvolatile memory. The nonvolatile memory can be read-only memory (ROM), programmable ROM (PROM), erasable Prom (EPROM), electrically erasable EPROM (EEPROM) or flash memory. Volatile memory can be random access memory (RAM), which is used as an external cache. By way of exemplary illustration, but not limitation, many forms of RAM are available, such as static RAM (SRAM), dynamic RAM (DRAM), synchronous DRAM (SDRAM), double data rate SDRAM (DDR SDRAM, enhanced SDRAM (ESDRAM), synch link DRAM (SLDRAM) and direct Rambus RAM (DR RAM).

It is to be noted that the memory described herein is intended to include, but is not limited to, these and any other suitable types of memories.

There is further provided a computer-readable storage medium for storing the computer program in the embodiments of the present disclosure. The computer-readable storage medium stores one or more programs including instructions that, when executed by a portable electronic device including a plurality of application programs, cause the portable electronic device to perform the methods provided herein. Optionally, the computer-readable storage medium can be applied to the first terminal device in the embodiments of the present disclosure, and the computer program enables the computer to perform the corresponding processes implemented by the first terminal device in the various methods of the embodiments of the present disclosure. For the sake of brevity, it will not be elaborated here. Optionally, the computer-readable storage medium can be applied to the second terminal device in the embodiments of the present disclosure, and the computer program enables the computer to perform the corresponding processes implemented by the second terminal device in the various methods in the embodiments of the present disclosure. For the sake of brevity, it will not be elaborated here.

There is further provided a computer program product including a computer program in the embodiments of the present disclosure. Optionally, the computer program product can be applied to the first terminal device in the embodiments of the present disclosure, and the computer program enables the computer to perform the corresponding processes implemented by the first terminal device in the various methods of the embodiments of the present disclosure. For the sake of brevity, it will not be elaborated here. Optionally, the computer program product can be applied to the second terminal device in the embodiments of the present disclosure, and the computer program enables the computer to perform the corresponding processes implemented by the second terminal device in the various methods in the embodiments of the present disclosure. For the sake of brevity, it will not be elaborated here.

There is further provided a computer program in the embodiments of the present disclosure. When the computer program is performed by the computer, such that the computer performs the method provided in the present disclosure. Optionally, the computer program can be applied to the first terminal device in the embodiments of the present disclosure. When the computer program runs on the computer, the computer performs the corresponding processes implemented by the first terminal device in various methods of the embodiments of the disclosure. For the sake of brevity, it will not be elaborated here. Optionally, the computer program can be applied to the second terminal device in the embodiments of the present disclosure. When the computer program runs on the computer, the computer performs the corresponding processes implemented by the second terminal device in various methods of the embodiments of the disclosure. For the sake of brevity, it will not be elaborated here.

There is further provided a communication system in the present disclosure. The communication system may include the first terminal device and the second terminal device described above, which will not be elaborated here for the sake of brevity. The terminology “system” and the like herein may also be referred to as “network management architecture”, “network system”, or the like.

There is further to be understood that the terminologies used in the embodiments of the present disclosure and the appended claims are for the purpose of describing particular embodiments only, and are not intended to limit the embodiments of the present disclosure. For example, as used in the embodiments of the present disclosure and the appended claims, the singular forms “a,” “an” and “the” are intended to include the plural forms as well, unless the context clearly dictates otherwise.

Those of ordinary skill in the art may realize that the units and algorithm steps of the various examples described in combination with the disclosed embodiments herein can be implemented by the electronic hardware, or the combination of computer software and electronic hardware. Whether these functions are performed in hardware or software depends on the specific application and design constraints of the technical solution. A professional technician may use different methods to implement the described functions for each specific application, but such implementation shall not be considered beyond the scope of the present disclosure. If it is implemented in the form of a software function unit and sold or used as an independent product, it can be stored in a computer readable storage medium. Based on such understanding, the technical solution of the present disclosure in essence or the part contributing to the related art or part of the technical solution may be embodied in the form of software product. The computer software product is stored in a storage medium, and several instructions are included for enabling a computer device (which may be a personal computer, a server, a network device, etc.) to perform all or part of the steps of the method according to the embodiments of the present disclosure. The aforementioned storage medium includes various medium capable of storing the program code, such as U disk, mobile hard disk, Read Only Memory (ROM), magnetic disk or optical disk.

Those skilled in the art may also realize that for the convenience and simplicity of the description, the specific working process of the system, device and unit described above can refer to the corresponding process in the method embodiments described above, and will not be elaborated here. In several embodiments provided in the present disclosure, it is to be understood that the disclosed system, device and method can be implemented in other ways. For example, the division of the modules in the device embodiments described above is only a logical function division, and there can be another division manner in actual implementation. For example, multiple modules or components can be combined or integrated into another system, or some features can be ignored or not implemented. For another example, the units/modules/components described above as separate/display components may or may not be physically separate, that is, they may be located in one place, or may be distributed over a plurality of network units. Some or all of the units/modules/components may be selected according to the actual needs to implement the purpose of the embodiments of the present disclosure. Finally, it is to be understood that the mutual coupling or direct coupling or communication connection illustrated or discussed above can be indirect coupling or communication connection through some interfaces, devices or units, and can be electric, mechanical or other forms.

The description above is only the specific embodiments of the present disclosure, and is not intended to limit the scope of protection of the embodiments of the present disclosure. Any variation and substitution that can be readily contemplated by those skilled in the art within the technical scope of the embodiments of the present disclosure shall fall within the protection scope of the embodiments of the present disclosure. Therefore, the protection scope of the embodiments of the disclosure is defined by the claims.

1. A method for acquiring configuration information, applied to a first terminal device, and comprising:
receiving first indication information transmitted by a first network device, wherein the first indication information indicates whether the first network device supports terminal-to-terminal relay; and
obtaining relay configuration information for the terminal-to-terminal relay based on the first indication information.

2. The method of claim 1, wherein the first indication information indicates that the first network device supports the terminal-to-terminal relay; and
wherein obtaining the relay configuration information for the terminal-to-terminal relay based on the first indication information comprises:
obtaining the relay configuration information from the first network device.

3. The method of claim 1, wherein the first indication information indicates that the first network device does not support the terminal-to-terminal relay; and
wherein obtaining the relay configuration information for the terminal-to-terminal relay based on the first indication information comprises:
obtaining the relay configuration information from a second terminal device which establishes a relay connection with the first terminal device.

4. The method of claim 1, wherein when the first indication information indicates that the first network device supports the terminal-to-terminal relay, the first indication information further indicates at least one of: a relay service type supported by the first network device, or a terminal type supported by the first network device for the terminal-to-terminal relay.

5. The method of claim 4, wherein a terminal type of the first terminal device is the terminal type supported by the first network device for the terminal-to-terminal relay, and a type of relay service expected to be transmitted by the first terminal device is the relay service type supported by the first network device; and
wherein obtaining the relay configuration information for the terminal-to-terminal relay based on the first indication information comprises:
obtaining the relay configuration information from the first network device.

6. The method of claim 4, wherein the relay service type comprises at least one of: a layer-2 terminal-to-terminal relay service, a layer-3 terminal-to-terminal relay service, a relay discovery service, or a non-relay discovery service.

7. The method of claim 6, wherein the relay discovery service comprises at least one of: a layer-2 relay discovery service, or a layer-3 relay discovery service.

8. The method of claim 3, wherein obtaining the relay configuration information from the second terminal device which establishes the relay connection with the first terminal device comprises:
transmitting a first request to the second terminal device, wherein the first request is used for requesting to obtain the relay configuration information; and
receiving the relay configuration information or a refusing response message transmitted by the second terminal device, wherein the refusing response message indicates that the second terminal device refuses to transmit the relay configuration information to the first terminal device.

9. The method of claim 2, wherein the first terminal device is in a Radio Resource Control (RRC) idle state or an RRC inactive state; and
wherein obtaining the relay configuration information from the first network device comprises:
obtaining the relay configuration information from a system message transmitted by the first network device.

10. The method of claim 2, wherein the first terminal device is in a Radio Resource Control (RRC) connected state; and
wherein obtaining the relay configuration information from the first network device comprises:
obtaining the relay configuration information from RRC configuration information transmitted by the first network device.

11. The method of claim 1, wherein the first indication information indicates whether the first network device supports the terminal-to-terminal relay by indicating whether the first network device has the capability to configure the first terminal device to perform the terminal-to-terminal relay.

12. The method of claim 1, wherein the relay configuration information comprises configuration information of a resource pool for the terminal-to-terminal relay.

13. A method for forwarding configuration information, applied to a second terminal device, and comprising:
receiving a first request transmitted by a first terminal device, wherein the first request is used for requesting to obtain relay configuration information for terminal-to-terminal relay; and
performing a reselection operation of a relay terminal or transmitting the relay configuration information or a refusing response message to the first terminal device, wherein the refusing response message indicates that the second terminal device refuses to transmit the relay configuration information to the first terminal device.

14. The method of claim 13, wherein before transmitting the relay configuration information or the refusing response message to the first terminal device, the method further comprises:
receiving third indication information transmitted by a second network device, wherein the third indication information indicates whether the second network device supports a terminal-to-terminal relay; and
wherein transmitting the relay configuration information or the refusing response message to the first terminal device comprises:
transmitting, based on the third indication information, the relay configuration information or the refusing response message to the first terminal device,
wherein when the third indication information indicates that the second network device supports the terminal-to-terminal relay, the third indication information further indicates at least one of: a relay service type supported by the second network device, or a terminal type supported by the second network device for the terminal-to-terminal relay,
wherein the relay service type comprises at least one of: a layer-2 terminal-to-terminal relay service, a layer-3 terminal-to-terminal relay service, a relay discovery service, or a non-relay discovery service.

15. The method of claim 13, wherein before transmitting the relay configuration information or the refusing response message to the first terminal device, the method further comprises:
obtaining fourth indication information transmitted by the second network device, wherein the fourth indication information indicates whether the second network device supports the second terminal to forward the relay configuration information to a peer terminal;
wherein transmitting the relay configuration information or the refusing response message to the first terminal device comprises:
transmitting, based on the fourth indication information, the relay configuration information or the refusing response message to the first terminal device,
wherein the second terminal device is in a Radio Resource Control (RRC) idle state or an RRC inactive state; and
wherein obtaining the fourth indication information transmitted by the second network device comprises:
obtaining the fourth indication information by transmitting request information to the second network device.

16. A first terminal device, comprising:
a transceiver, a processor and a memory, wherein the memory is configured to store a computer program,
the processor is configured to call and run the computer program stored in the memory to enable the transceiver to:
receive first indication information transmitted by a first network device, wherein the first indication information indicates whether the first network device supports a terminal-to-terminal relay; and
obtain relay configuration information for the terminal-to-terminal relay based on the first indication information.

17. The first terminal device of claim 16, wherein the first indication information indicates that the first network device supports the terminal-to-terminal relay; and
wherein the obtaining unit is specifically configured to:
obtain the relay configuration information from the first network device,
and/or wherein the first indication information indicates that the first network device does not support the terminal-to-terminal relay; and
the processor is specifically configured to call and run the computer program stored in the memory to enable the transceiver to:
obtain the relay configuration information from a second terminal device which establishes a relay connection with the first terminal device.

18. The first terminal device of claim 16, wherein when the first indication information indicates that the first network device supports the terminal-to-terminal relay, the first indication information further indicates at least one of: a relay service type supported by the first network device, or a terminal type supported by the first network device for the terminal-to-terminal relay,
wherein a terminal type of the first terminal device is the terminal type supported by the first network device for the terminal-to-terminal relay, and a type of relay service expected to be transmitted by the first terminal device is the relay service type supported by the first network device; and
the processor is specifically configured to call and run the computer program stored in the memory to enable the transceiver to:
obtain the relay configuration information from the first network device,
wherein the relay service type comprises at least one of: a layer-2 terminal-to-terminal relay service, a layer-3 terminal-to-terminal relay service, a relay discovery service, or a non-relay discovery service,
wherein the relay discovery service comprises at least one of: a layer-2 relay discovery service, or a layer-3 relay discovery service.

19. The first terminal device of claim 17, the processor is specifically configured to call and run the computer program stored in the memory to enable the transceiver to:
transmit a first request to the second terminal device, wherein the first request is used for requesting to obtain the relay configuration information; and
receive the relay configuration information or a refusing response message transmitted by the second terminal device, wherein the refusing response message indicates that the second terminal device refuses to transmit the relay configuration information to the first terminal device,
wherein the first terminal device is in a Radio Resource Control (RRC) idle state or an RRC inactive state; and
wherein the obtaining unit is specifically configured to:
obtain the relay configuration information from a system message transmitted by the first network device,
wherein the first terminal device is in a Radio Resource Control (RRC) connected state; and
wherein the obtaining unit is specifically configured to:
obtain the relay configuration information from RRC configuration information transmitted by the first network device.

20. A second terminal device, comprising:
a transceiver, a processor and a memory, wherein the memory is configured to store a computer program,
the processor is configured to call and run the computer program stored in the memory to enable the transceiver and/or processor to perform the method of claim 13.
